(19) United States
(12) Patent Application Publication
(10) Pub. No.: US 2025/0269350 A1
(43) Pub. Date: Aug. 28, 2025

(54) COMPOSITIONS AND METHODS FOR REMEDIATION USING DITHIONITE AND ACTIVATED CARBONS

(71) Applicants: Benjamin V. Mork, Newport Coast, CA (US); Sarah C. Juhl-Harris, Irvine, CA (US)

(72) Inventors: Benjamin V. Mork, Newport Coast, CA (US); Sarah C. Juhl-Harris, Irvine, CA (US)

(21) Appl. No.: 18/252,687

(22) PCT Filed: Apr. 21, 2023
(86) PCT No.: PCT/US23/66077

§ 371 Date: May 11, 2023

Related U.S. Application Data
(60) Provisional application No. 63/363,462, filed on Apr. 22, 2022.

(51) Int. Cl. B01J 20/20; B01J 20/28; B09C 1/00; B09C 1/08; C02F 1/28; C02F 1/66; C02F 1/70; C02F 101/36; C02F 103/06

(52) U.S. Cl. CPC B01J 20/20; B01J 20/28004; B01J 20/28016; B09C 1/002; B09C 1/08; C02F 1/283; C02F 1/66; C02F 1/70; B09C 2101/00; C02F 2101/36; C02F 2103/06

(57) ABSTRACT

The present invention comprises methods and compositions for the treatment of contaminated groundwater and soil, or other media, with a mixture comprised of a sorbent, dithionite, and a pH controller.

### PRIORITY CLAIM

This application claims priority to and/or the benefit of U.S. provisional patent application Ser. No. 63/363,462 filed Apr. 22, 2022, The foregoing application is incorporated by reference in its entirety as if fully set forth herein.

### FIELD OF THE INVENTION

This invention relates generally to methods and compositions for the treatment or remediation of contaminated groundwater, soil, or a combination thereof including combinations with other substances, and may have further application in other media. The invention herein is not necessarily limited to such applications and can further be implemented on other media for decontamination purposes.

### BACKGROUND OF THE INVENTION

There are thousands of contaminated sites in the United States and abroad in need of remediation. The National Research Council and other US and international agencies have estimated that there are large and increasing numbers of contaminated groundwater sites. For example, the NRC estimated in 2013 that there are over 126,000 contaminated sites in the US, and there would be treatment needed on over 300,000 sites by 2033. Contamination at these sites, typically in groundwater and soil, results from past accidental or intentional releases of petroleum hydrocarbons, chlorinated solvents, pesticides, metals, and other industrially useful toxic chemicals. Types of contaminated sites include military bases, gasoline stations, fuel terminals, pipelines, dry cleaners, aerospace facilities, and industrial manufacturing facilities, among others. As new technologies proliferate and are discovered, additional forms of sites may become available or more common.

Government regulators, property owners, responsible parties, and environmental consultants have significant ongoing efforts to clean up and manage these contaminated sites. Through a variety of available methods, stakeholders for contaminated sites work to balance regulatory requirements, human health risks, community concerns, environmental protection, and costs. Due to the high costs of remediation, there is a need for new technologies that clean-up sites more quickly, effectively, and at lower costs than currently available methods, hence the need for the present invention. Additionally, demand is increasing for remediation methods with a smaller carbon footprint and reduced secondary environmental impact.

Groundwater remediation methods generally fall into one of three categories: in situ methods, ex situ methods, and removal. In situ refers to in-place treatment of contaminated soil and water. This approach has the benefit of minimal disturbance to the site and can be lower cost than alternatives because it removes the need to extract the contaminated materials. Ex situ methods involve removing the water or soil from the ground for treatment, then placing it back into the site. For example, “Pump & Treat” is an ex situ treatment method where water is pumped from the ground, purified (e.g. with activated carbon or a similar decontaminant), a re-injected to the aquifer. Removal methods, such as dig-and-haul, transport the contaminated soil or water to be disposed of or treated at a hazardous waste facility or stored. The site is then backfilled with clean materials, Removal methods have high success rates; however, they also have high costs and a large carbon footprint. In situ remediation methods are desirable for having lower costs, lower carbon footprint, and less disturbance to sites and surrounding communities. However, success rates of in situ treatments are typically lower than desired due to the limited efficacy and selectivity of chemical and biological treatments used for in situ remediation. There is a general need for new methods that improve the effectiveness of in-situ groundwater and soil remediation.

As described in the foregoing, injection of remediation agents into contaminated groundwater is a popular approach to in situ cleanup, and the present invention presents a composition for such purpose that resolves many of the existing problems. A wide variety of chemical and biological agents are injected for remediation, including reducing agents, oxidizing agents, bacteria, adsorbents, and compounds that stimulate bioremediation (biological electron donors and electron acceptors). In situ chemical oxidation (ISCO) is a widely used technology for destruction of hydrocarbon and halogenated organic groundwater contaminants. However, ISCO is an unselective process and much of the oxidant is wasted by side reactions with naturally occurring minerals and organic materials in soil. It also leaves the groundwater in a highly oxidized state and is slow to transition back to anaerobic conditions that are frequently necessary for subsequent bioremediation treatments. ISCO may also form undesired oxidized halogenated byproducts. The present invention improves on this issue by treating contaminants under reducing conditions, leaving the groundwater in a reduced state compatible with other reducing technologies that could be used either before or after the present invention to achieve site goals.

In situ chemical reduction (ISCR) has been widely practiced for over 40 years for remediation of groundwater contaminated with halogenated organic compounds. Most ISCR treatments utilize solid particles of iron metal, referred to as zerovalent iron (ZVI). Contaminant destruction in the ZVI-based ISCR process require direct contact of contaminants with the surface of the metal particles, which limits the rate and selectivity of these reactions. Metal particles generally have low surface area and poor ability to adsorb contaminants for reaction. Corrosion and other unproductive iron-oxidation reactions compete with contaminants to consume and waste the metal particles, limiting the selectivity of the ISCR process. Using the disclosed invention, these drawbacks are at least in part resolved because the contaminants are absorbed preferentially onto the activated carbon particles, which also perform the chemical reduction reactions in combination with the other disclosed chemicals. The disclosed invention also utilizes a soluble reducing agent (dithionite ion), which can distribute much more easily into the soil and groundwater than conventional, insoluble SCR agents such as ZVI.

Sodium dithionite has previously been tested in environmental remediation ISCR applications and has even been proposed for treatment of halogenated ethenes such as TC. These processes, known as in situ redox manipulation (ISRM), require the presence of certain reactive iron-based minerals and therefore may not be effective on all sites. For this and other reasons, ISRM approaches have not found commercial success for treatment of halogenated ethenes in the approximately 30 years since their discovery. The present invention overcomes these challenges by providing a controlled, effective chemical reduction process for halogenated organic compounds that does not rely on site-specific mineral or groundwater constituents.

Bioremediation is effective and is also used extensively for in situ treatment of halogenated organics. Enhanced Reductive Dechlorination (ERD) is a process where bioremediation rates are enhanced by addition of biological electron donors (biodegradable non-toxic organics) such as soybean oil. However, these biological processes are slow, taking months or years to complete, and are only effective at low concentrations of contaminants. Bioremediation of chlorinated contaminants such as TCE can also result in conversion to high concentrations of toxic intermediates like cis-1,2-dichloroethene and vinyl chloride.

Among the most common groundwater contaminants are halogenated organics such as the chlorinated ethenes perchloroethene (PCF) and trichloroethene (TCE), and their degradation products cis-1,2-diehloroethene (cis-1-2-DCE), and vinyl chloride (VC). ISCR, ISO), and bioremediation methods are commonly applied to treat these contaminants in situ, and some of the limitations in efficiency and selectivity of these approaches are listed above.

Adsorbent materials such as activated carbon is effective at rapidly decreasing groundwater contaminant concentrations when applied in situ. However, without contaminant destruction mechanisms, there is a risk of desorption or displacement of those adsorbed contaminants from the carbon in the future. In effect, while activated carbon can absorb the contaminants, it does not necessarily remediate them, resulting in situations where long-term the contaminants may be reintroduced to the site or otherwise create a secondary contamination. Activated carbon with embedded ZVI is known, and is also effective for halogenated organics treatment, however it is costly to manufacture and difficult to distribute into groundwater due to its large particle size. The solution, as presented herein, is to combine the absorption of the activated carbon with a treatment means that lacks the drawbacks of ZVI, resulting in more efficient remediation without the issue of contaminants being essentially stored in the activated carbon.

There is a need for new technologies that degrade halogenated contaminants rapidly, are easy to apply as soluble chemicals, and are cost effective. Materials and methods that simultaneously adsorb and destroy contaminants provide multiple benefits including very rapid groundwater treatment and enhancement of the rates and extent of contaminant destruction.

Contemplated embodiments of the present invention address the above needs and limitations and provide additional new advantages for groundwater and soil remediation.

### BRIEF SUMMARY

Specific details of certain embodiments of the invention are set forth in the following description and in the figures to provide a thorough understanding of such embodiments. The present invention may have additional embodiments, may be practiced without one or more of the details described for any particular described embodiment, or may have any detail described for one particular embodiment practiced with any other detail described for another embodiment.

This invention relates to methods and compositions for the treatment of contaminated groundwater and soil containing chemically reducible contaminants including, but not limited to halogenated organic compounds. The method of the present invention uses a dithionite compound in combination with activated carbon and a base, where the pH is alkaline (>7). This combination is introduced into the groundwater or soil in a manner which assures that the activated carbon adsorbs and then chemically reduces the contaminants, rendering them harmless. While many embodiments rely on the pH being alkaline, some embodiments may be practiced in neutral or acidic environments.

### BRIEF DESCRIPTION OF THE DRAWINGS

Embodiments of the present invention are described in detail below with reference to the following drawings:

FIG. 1 depicts the plotted TCE concentration data from Example 1, in accordance with an embodiment of the invention;

FIG. 2 depicts the plotted PCE concentration data from Example 2, in accordance with an embodiment of the invention;

FIG. 3 the plotted cis-DCE concentration data from Example 3, in accordance with an embodiment of the invention;

FIG. 4 depicts the plotted chlorinated ethene data from Example 4, in accordance with an embodiment of the invention; and

FIG. 5 depicts the plotted TCE-data from Example 5, in accordance with an embodiment of the invention.

### DETAILED DESCRIPTION

Herein discloses new methods and compositions for treating groundwater and/or soil, or other media, that is contaminated with halogenated organics or other chemically reducible compounds using in situ or other methods of remediation. Contemplated embodiments can be described as adsorption and chemical reduction treatment of soil and groundwater contaminants by providing a dithionite compound, activated carbon (or other sorbent), and a base, however, some embodiments of the invention may omit one or more of the components or add other components.

In some embodiments, the dithionite compound, activated carbon, and a pH1 controlling substance, sometimes a base, can be applied to contaminated groundwater or soil as a mixture. In some embodiments, these chemicals can be applied separately. For example, in some sites the pH controller may be added first to achieve the desired pH, or a pH controller and/or activated carbon may have been added in previous remediation treatments thus negating the need to add more. In some contemplated embodiments, each chemical is added separately. Some embodiments may involve addition of the chemicals through different means; for example, some may be injected into the groundwater or soil while others may be poured atop it and permitted to mix upon contact. In some embodiments of the invention, the activated carbon can be substituted for another, alternative sorbent material such as, but not limited to, biochar, zeolite particles, silica particles, alumina particles, clay particles, or combinations thereof, or the activated carbon can be mixed with such substances to improve absorption of various compounds.

Halogenated organic contaminants treated by the present invention include but are not limited to chlorinated alkenes, chlorinated alkanes, chlorinated aromatics, chlorofluorocarbons, fluorinated organic compounds, and brominated alkanes. Chlorinated alkenes include but are not limited to the chlorinated ethenes TCE, PCE, DCE, and vinyl chloride (VC). Chlorinated alkanes include but are not limited to methylene chloride, 1,2-dichloroethane (1,2-DCA), 1,1,1-trichloroethane (1,1,1-TCA), 1,1-dichloroethane, carbon tetrachloride, and chloroform. Chlorinated aromatics include but are not limited to chlorobenzenes. Brominated alkanes include but are not limited to ethylene dibromide. Other chemically reducible contaminants treated by the present invention include nitro compounds such as nitrobenzenes, explosive compounds including but not limited to RDX (hexogen), IMX (octogen), and TNT (trinitrotoluene), and reducible metal contaminants including but not limited to chromium (VI).

In contemplated embodiments, the dithionite compound, activated carbon, and pH controller can be introduced to the contaminated groundwater or soil by any remediation chemical delivery method including direct push injection, injection into wells, fracturing methods, depositing the chemicals into excavations, and soil mixing. By any of these methods, the dithionite compound, activated carbon, and base can be added as a mixture or separately. The dithionite compound, activated carbon, and base can be added as liquid solutions, slurries, dispersions or colloids. In some contemplated embodiments, the chemicals can be added as dry solids to contaminated groundwater or soil. Additional water can be added after the chemicals are added to, for example, contaminated excavations. In some further embodiments, the components of the mixture may be added separately through differing means, such as, for example, the activated carbon and pH controller could be added through direct push injection while the dithionite compound could be added by fracturing.

The dithionite compound can be any source of dithionite ion (S₂O₄²⁻), including sodium dithionite, potassium dithionite, calcium dithionite, magnesium dithionite, or ammonium dithionite. The dithionite anion is a chemical reducing agent with a wide range of applications such as textile dyeing, paper manufacturing, and conservation of historical artifacts. Dithionite acts as a reducing agent in some chemical reactions by providing electrons to chemically reducible species. In the present invention, the activated carbon is found to enhance the transfer of electrons from the dithionite anion for chemical reduction of chemically reducible contaminants. This process enables chemical reduction of contaminants that otherwise exhibit very little or no direct reaction with dithionite, such as TCE.

The activated carbon can be used in any available form. The particle size of the activated carbon can be anywhere from 10 nanometers to 20 mm in size. The most available and useful forms of activated carbon are granular activated carbon (typically >1 mm average particle diameter), powdered activated carbon (typically 5-50 μm average particle diameter), and colloidal activated carbon, (typically 0.5-5 μm average particle diameter). Similar particle sizes could be applied to other sorbent materials if used in place of activated carbon. The invention could also be practiced utilizing alternative sizes of activated carbon or sorbents, even below or exceeding 10 nanometers to 20 mm, as new variants are invented. Similarly, other sorbents presently or later invented could potentially replace the activated carbon and be used in similar size ranges, or such sizes as appropriate to those specific sorbents.

The base or pH controller can be any chemical compound that shifts the pH of the water into the desired range. Examples include but are not limited to hydroxides of alkali metals and alkaline earth metals such as sodium hydroxide, potassium hydroxide, magnesium hydroxide, and calcium hydroxide. Other contemplated embodiments include alkali metal carbonates and alkali metal phosphates including sodium carbonate, potassium carbonate, sodium phosphate, and potassium phosphate. In some embodiments, it may be preferable to raise the pH to greater than 7, while in other circumstances a more acidic or neutral pH may be preferable. The amount of pH controller required to modify groundwater pH can vary widely due to variables such as buffering capacity and starting pH. In general, some embodiments will operate at a pH at or above about pH 9. Other embodiments of the invention have a pH value in the range of 10-13. Generally, but not exclusively, higher pH values may present safety concerns, and lower pH values exhibit slower reaction rates. Naturally, the ratio of pH controller to the other substances present in the mixture will depend on the pH of the controller as well as the amount of the other substances.

The ratios of a dithionite compound to activated carbon in contemplated embodiments can be any combination that has a commercially useful concentration for each ingredient. In typical use, the maximum concentration of sodium dithionite is limited by its solubility in water, which is about 20% by weight, but in some circumstances this amount may vary. Activated carbon, which is insoluble in water, could have a concentration of up to about 50% by weight in pre-treatment slurries, though under the right circumstances this amount may vary. Contemplated embodiments would have a ratio of (dithionite compound):(activated carbon) between 1:0.001 and 1:100, The range of useful dithionite compound concentrations would be from about 100 mg/L up to 20% w/w. The range of useful activated carbon concentrations would be from about 100 mg/L up to 50% w/w. In some situations, variations of the invention with alternative ratios may be desirable, including those well outside those described herein, as necessary to ensure proper remediation.

The following examples further illustrate the present invention and demonstrate its effectiveness but should not be construed in any way limiting its scope.

### Example 1

### Treatment of TCI-Contaminated Water

This example demonstrates the destruction of TCE, one of the most common halogenated groundwater contaminants. The treatment is compared to a series of controls to distinguish TCE destruction from simple adsorption processes, and to demonstrate that activated carbon is needed for the destruction to proceed.

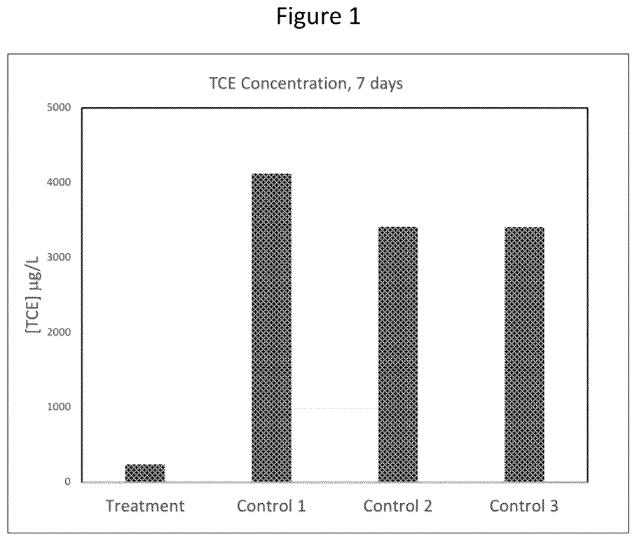

A treatment mixture was prepared containing 1% w/w sodium dithionite, 500 mg/L colloidal activated carbon, 0.2 M sodium hydroxide, and 5,000 μg/L TCL. The sample was prepared by adding 0.200 g of sodium dithionite (Na₂S₂O₄) to a 20 mL glass vial, followed by 10.0 mL of water and 5.0 mL of 2,000 mg/L colloidal activated carbon. Sodium hydroxide (4.0 mL, 1.0 M) was then added to the mixture and the vial was sealed and shaken briefly to dissolve the dithionite. The TCE stock solution (1.0 ml of 100 mg/L) was then added to the mixture b syringe. All vials in this study were sealed with leak-tight, PTFE, syringe-accessible caps. A TCE control sample (Control 1) was prepared by adding 1.0 mL of a 100 mg/L TCE stock solution to 19.0 ml of water in a 20 ml, sealed glass vial. Control 2, an activated carbon/TCE control sample, was prepared by adding 5.0 mL of 2,000 mg/L colloidal activated carbon dispersion and 1.0 mL of a 100 mg/L TCE stock solution to 14.0 mL of water in a sealed vial. Control 3, containing only sodium dithionite, sodium hydroxide, and TCE was prepared by adding 0.200 g sodium dithionite. 4.0 mL of 1.0 M sodium hydroxide, and 1.0 mL of 100 mg/L TCE to 15.0 mL of water. The mixtures were shaken briefly to mix and then stored at room temperature. After seven days, the TCE concentration in each water phase was measured by gas chromatography-mass spectrometry (GC-MS) Samples were diluted by a factor of 20 in water for analysis. The sample names, compositions, and TCE concentrations in the reaction and control samples are shown in Table 1 and FIG. 1.

TABLE 1

| | | [TCE] | Change vs. TCE |
|---|---|---|---|
| Sample | Composition | (μg/L) | control |
| Treatment | Na₂S₂O₄/AC/NaOH/TCE | 242 | −94% |
| Control 1 | TCE | 4,124 | — |
| Control 2 | AC/TCE | 3,413 | −17% |
| Control 3 | Na₂S₂O₄/NaOH/TCE | 3,407 | −17% |

The treatment resulted in a 94% decrease in TCE compared to a control with only TCE (Control 1). To account for any concentration decreases due only to adsorption, Control 2 vas prepared with only activated carbon and TCE. Control 3 was prepared with only dithionite and sodium hydroxide, Controls 2 and 3 exhibited only slight decreases in concentration compared with the treatment sample, demonstrating the efficacy of the present invention and the need for a sorbent such as, but not limited to, activated carbon, to be present for treatment to occur.

### Example 2

### Treatment of PCE-Contaminated Water

This example demonstrates the destruction of PCE, a very common halogenated groundwater contaminant. The treatment is compared to two controls in order to distinguish PCE destruction from simple adsorption or volatilization processes.

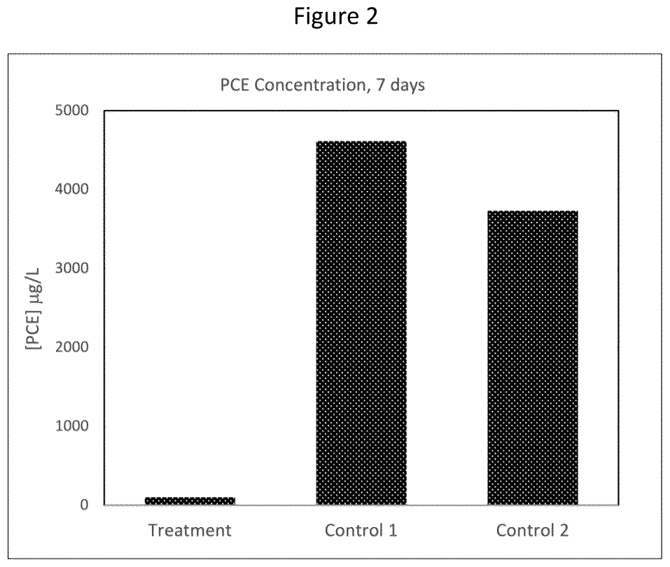

A treatment mixture was tested containing 1% w/w sodium dithionite, 100 mg/L colloidal activated carbon, 0.2 M sodium hydroxide, and 5,000 μg/L PCE. The sample was prepared by adding 0.200 g of sodium dithionite (Na₂S₂O₄) to a 20 mL glass vial, followed by 13.0 mL of water and 1.00 mL of 2,000 mg/L colloidal activated carbon (AC). Sodium hydroxide (4.0 mL, 1.0 M) was then added to the mixture and the vial was sealed and shaken briefly to dissolve the dithionite. The PCE stock solution (2.0 mL of 50 mg/L PCE) was then added to the mixture by syringe. All vials in this study were sealed with leak-tight, PTFE, syringe-accessible caps. A PCE control sample (Control 1) was prepared by adding 2.0 ml, of a 50 mg/L PCE stock solution to 18.0 mL of water in a 20 mL sealed glass vial. Control 2, an activated carbon/PCE control sample, was prepared by adding 1.00 mL of 2,000 mg/L colloidal activated carbon dispersion and 2.0 ml of a 50 mg/L PCE stock solution to 17.0 mL of water in a sealed vial. The mixtures were shaken briefly and placed on the laboratory bench at room temperature. After seven days, the PCE concentration in each sample was measured by gas chromatography-mass spectrometry (GC-MS), Samples were dilated by a factor of 20 in water for analysis. The sample names, compositions, and PCE concentrations in the reaction and control samples are shown in Table 2 and FIG. 2.

TABLE 2

| | | [PCE] | Change vs. PCE |
|---|---|---|---|
| Sample | Composition | (μg/L) | control |
| Treatment | Na₂S₂O₄/AC/NaOH/PCE | 103 | −98% |
| Control 1 | PCE | 4,613 | — |
| Control 2 | AC/PCE | 3,731 | −19% |

The treatment resulted in a 98% decrease in PCE compared to a control with only PCE (Control 1), To account for any concentration decreases due only to adsorption, Control 2 was prepared with only activated carbon and TCE. Control 2 exhibited only a 19% decrease in contaminant concentration, demonstrating the efficacy of the present invention for destruction of PCE and treatment of PCE-contaminated groundwater and soil.

### Example 3

### Treatment of cis-1,2-DCE-Contaminated Water

This example demonstrates the destruction of cis-1,2-DCE (DCE), a toxic decomposition product commonly observed in TCE-contaminated groundwater. The treatment is compared to two controls that distinguish DCE destruction from simple adsorption or volatilization processes.

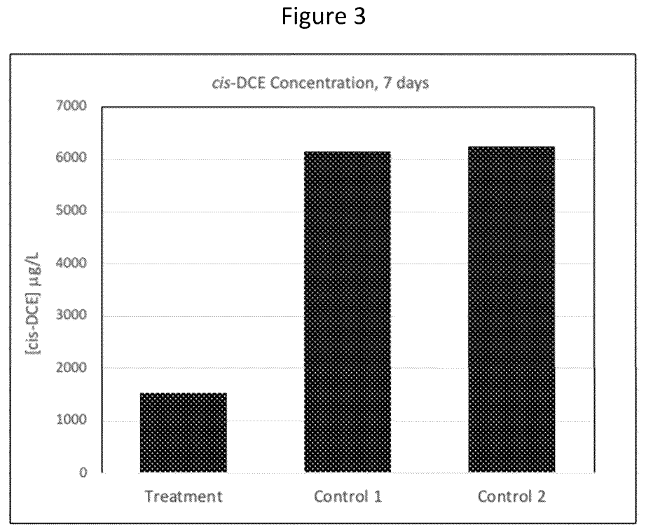

A treatment mixture was tested containing 1% w/w sodium dithionite, 500 mg/L colloidal activated carbon, 0.2 M sodium hydroxide, and 5,000 μg/L cis-1,2-dichloroethene (cis-DCE). The sample was prepared by adding 0.200 g of sodium dithionite (Na₂S₂O₄) to a 20 mL glass vial, followed by 10.0 ml of water and 5.00 mL of 2,000 mg/L colloidal activated carbon (AC). Sodium hydroxide (4.0 mL. 1.0 M) was then added to the mixture and the vial was sealed and shaken briefly to dissolve the dithionite. The cis-DCE stock solution (1.00 mL of 100 mg/L cis-DCE) was then added to the mixture by syringe. All vials in this study were sealed with leak-tight, PTFE, syringe-accessible caps, A cis-DCE control sample (Control 1) was prepared by adding 1.00 mL of a 100 mg/L cis-DCE stock solution to 19.0 ml, of water in a 20 mL sealed glass vial. Control 2, an activated carbon/cis-DCE control sample, was prepared by adding 5.00 mL of 2,000 mg/L colloidal activated carbon dispersion and 1.00 mL of a 100 mg/L cis-DCE stock solution to 14.0 mL of water in a sealed vial. The mixtures were shaken briefly and placed on the laboratory bench at room temperature. After seven days, the cis-DCE concentration in each sample was measured by gas chromatography-mass spectrometry (GC-MS). Samples were diluted by a factor of 20 in water for analysis. The sample names, compositions, and cis-DCE concentrations in the reaction and control samples are shown in Table 3 and FIG. 3.

TABLE 3

| | | [cis-DCE] | Change vs. cis-DCE |
|---|---|---|---|
| Sample | Composition | (μg/L) | control |
| Treatment | Na₂S₂O₄/AC/NaOH/ | 1,533 | −75% |
| | cis-DCE | | |
| Control 1 | cis-DCE | 6,146 | — |
| Control 2 | AC/cis-DCE | 6,246 | +1.6% |

The treatment resulted in a 75% decrease in DCE concentration compared to a control with only DCE (Control 1). To account for any concentration decreases due only to adsorption, Control 2 was prepared with only activated carbon and TCE. Control 2 exhibited no significant change in contaminant concentration, demonstrating the efficacy of the present invention for destruction of DCE and treatment of DCE-contaminated groundwater and soil.

### Example 4

### TCE Treatment with Extraction and Reduction Products Analysis

This example further demonstrates the destruction of TCE with the use of solvent extraction and analysis of the potential intermediates of chemical reduction, DCE and vinyl chloride (VC). Inclusion of 1% butanol in the analysis mixture ensures that all contaminants are displaced from activated carbon for quantification. Detection and measurement of DCE and VC gives direct evidence of destruction of TCE.

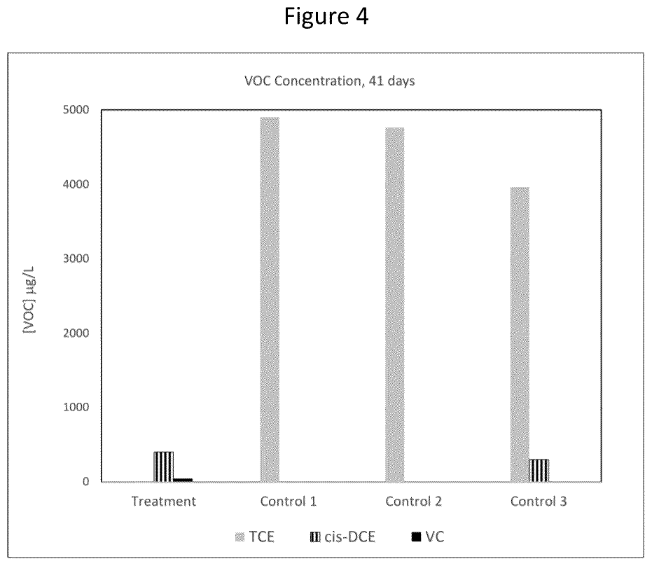

A treatment mixture was tested containing 1% w/w sodium dithionite, 1000 mg/L colloidal activated carbon, 0.2 M sodium hydroxide, and 5,000 μg/L TCE. The treatment sample was prepared by adding 1.250 g of sodium dithionite (Na₂SO₄) to a 125 mL glass bottle, followed by 47.5 mL of water and 62.5 mL of 2,000 mg/L colloidal activated carbon (AC). Sodium hydroxide (12.5 mL, 1.0 M) was then added to the mixture and the bottle was sealed and shaken briefly to dissolve the dithionite. The TCE stock solution (2.5 mL of 250 mg/L TCE) was then added to the mixture by syringe. All bottles in this study were sealed with leak-tight, PTFE, syringe-accessible caps. A TCE control sample (Control 1) was prepared by adding 2.5 ml, of a 250 mg/L TCE stock solution to 122.5 mL of water in a 125 mL sealed glass bottle. Control 2, an activated carbon/TCE control sample, was prepared by adding 62.5 mL of 2.000 mg/L colloidal activated carbon dispersion and 2.5 mL of a 250 mg/L TCE stock solution to 60.0 mL of water in a sealed bottle. Control 3, an alkaline sodium dithionite mixture, was prepared by adding 1.250 g of sodium dithionite (Na₂S₂OC) to a 125 mL glass bottle, followed by 110 mL of water. Sodium hydroxide (12.5 mL, 1.0 M) was then added to the mixture, followed by 2.5 mL of a 250 mg L TCE stock solution. The mixtures were sealed and shaken briefly and placed on the laboratory bench at room temperature. After 41 days, the volatile organic compound (VOC) concentrations in each sample were measured gas chromatography-mass spectrometry (GC-MS). Samples were diluted by a factor of 20 in a 1% butanol/99% water mixture for analysis. The sample names, compositions, and TCE concentrations in the reaction and control samples are shown in Table 4 and FIG. 4.

TABLE 4

| | | | | | | Change in total |
|---|---|---|---|---|---|---|
| | | [TCE] | [cis-DCE] | [VC] | Total VOCs | VOCs vs. TCE |
| Sample | Composition | (μg/L) | (μg/L) | (μg/L) | (μg/L) | control |
| Treatment | Na₂S₂O₄/AC/NaOH/TCE | 18 | 403 | 47 | 468 | −90% |
| Control 1 | TCE | 4,909 | 0 | 0 | 4,909 | — |
| Control 2 | AC/TCE | 4,768 | 0 | 0 | 4,768 | −3% |
| Control 3 | Na₂S₂O₄/NaOH/TCE | 3,968 | 301 | 0 | 4,269 | −13% |

The treatment resulted in destruction of 99.6% of the TC E present in the sample. Small amounts of DCE and VC were also observed in the treatment sample, suggesting that the TCE is destroyed by hydrodehalogenation mechanisms (chemical reduction of carbon-chlorine bonds where chlorine is replaced with hydrogen). These low levels of DCE and VC present are a much lower fraction than typically observed for bioremediation of TCE, indicating that the present invention can destroy high concentrations of halogenated organic contaminants with very little production of toxic intermediates. The TCE was fully recovered in Control 2, which contains only activated carbon and TCE. Only a small amount of reactivity was observed in control 3, decreasing the total VOCs by 13% and demonstrating that the sorbent, in this case activated carbon, plays an important role in this alkaline chemical reduction process. In comparison, the treatment sample demonstrated a 90% reduction of total VOCs after 7 days.

### Example 5

### TCE Treatment with Phosphate Base

This example demonstrates the destruction of TCE using phosphate as a pH controller to shift the pH balance of the mixture towards basic. The use of phosphate demonstrates that bases other than alkali metal hydroxides can also be used in the present invention.

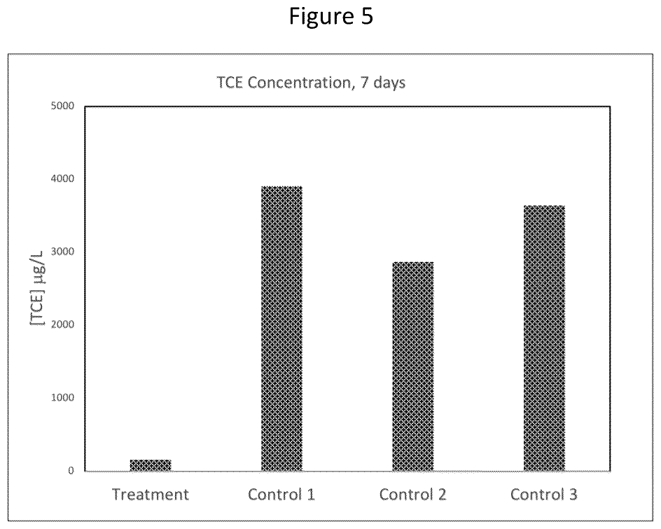

A treatment mixture was prepared containing 1% w/w sodium dithionite, 500 mg/L colloidal activated carbon, 0.2 M sodium phosphate (Na₃PO₄) and 5,000 μg/L TCE. The sample was prepared by adding 0.200 g of sodium dithionite (Na₂S₂O₄) to a 20 mL glass vial, followed by 14.0 mL of water and 5.0 mL of 2,000 mg/L colloidal activated carbon. Sodium phosphate (0.656 g) was then added to the mixture and the vial was sealed and shaken briefly to dissolve the solids. The TCE stock solution (1.0 mL of 100 mg/L) was then added to the mixture by syringe. All vials in this study were sealed with leak-tight, PTFE, syringe-accessible caps. A TCE control sample (Control 1) was prepared by adding 1.0 mL of a 100 mg/L. TCE stock solution to 19.0 mL of water in a 20 mL sealed glass vial. Control 2, an activated carbon/TCE control sample, was prepared by adding 5.0 mL of 2,000 g/L colloidal activated carbon dispersion and 1.0 mL of a 100 mg/L TCE stock solution to 14.0 mL of water in a sealed vial. Control 3, containing only sodium dithionite, sodium phosphate, and TCE was prepared by adding 0.200 g sodium dithionite, 0.656 g Na₃PO₄, and 1.0 mL of 100 mg/L TCE to 19.0 mL of water. The mixtures were shaken briefly to mix and then stored at room temperature. After seven days, the aqueous TCE concentration in each sample was measured by gas chromatography-mass spectrometry (GC-MS). Samples were diluted by a factor of 20 in water for analysis. The sample names, compositions, and TCE concentrations in the reaction and control samples are shown in Table 5 and FIG. 5.

TABLE 5

| | | [TCE] | Change vs. TCE |
|---|---|---|---|
| Sample | Composition | (μg/L) | control |
| Treatment | Na₂S₂O₄/AC/Na₃PO₄/TCE | 161 | −96% |
| Control 1 | TCE | 3,905 | — |
| Control 2 | AC/TCE | 2,865 | −27% |
| Control 3 | Na₂S₂O₄/Na₃PO₄/TCE | 3,639 | −7% |

After 7 days, the treatment sample showed 96% destruction of the TCE contaminant compared with the TCE-only control. Control 2, which also contained activated carbon, exhibited a 27% decrease in TOE concentration solely due to adsorption. The phosphate-dithionite control showed no significant change in TCE concentration. The dithionite, activated carbon, and sodium phosphate treatment data demonstrates that bases other than hydroxide can be used in this invention.

### Example 6

### Reactivity of Powdered Activated Carbon

This example demonstrates the use of different types of activated carbon. Examples 1 through 5 use a colloidal from of activated carbon, having a small average particle diameter of approximately 2 μm. In this example, a commonly available commercial form of activated carbon, FAC, is used to demonstrate the invention. Commercial PAC is typically size graded to −325 mesh (<44 μm) with an average particle diameter of approximately 30 microns.

A treatment mixture was prepared containing 1% w/w sodium dithionite, 500 mg/L powdered activated carbon (PAC), 0.2 M sodium hydroxide, and 5,000 μg/l TCE The sample was prepared by adding 0.200 g of sodium dithionite (Na₂S₂O₄) to a 20 mL glass vial, followed by 15.0 mL of water and 0.010 g of PAC. Sodium hydroxide (4.0 mL, 1.0 M) was then added to the mixture and the vial was sealed and shaken briefly to dissolve the dithionite. The TCE stock solution (1.0 mL of 100 mg/L) was then added to the mixture by syringe. All vials in this study were sealed with leak-tight, PTFE, syringe-accessible caps. The control sample, a PAC/TCE control sample, was prepared by adding 0.010 g of PAC and 1.0 mL of a 100 mg/L TCE stock solution to 19.0 mL of water in a sealed vial. The mixtures were shaken briefly to mix and then stored at room temperature. After seven days, the TCE concentration in each water phase was measured by gas chromatography-mass spectrometry (GC-MS). Samples were diluted by a factor of 20 in water for analysis. The sample names, compositions, and ICE concentrations in the reaction and control samples are shown in Table 6.

TABLE 6

| | | [TCE] | |
|---|---|---|---|
| Sample | Composition | (μg/L) | Change vs. control |
| Treatment | Na₂S₂O₄/PAC/NaOH/TCE | 283 | −40% |
| Control | PAC/TCE | 469 | — |

The TCE contamination in the treatment sample after seven days was reduced by 40% in comparison with the control that contains only PAC. This demonstrates that activated carbon of various sizes is effective for treatment in embodiments of the present invention.

### Example 7

### Non-Reactivity of Other Forms of Carbon

This example demonstrates other forms of elemental carbon are less effective for treatment of contaminated water in this manner, and that activated carbon is preferred for many embodiments of the invention. Graphite is an allotrope of carbon that has a layered, hexagonal structure and has a wide range of applications in chemistry. Amorphous, glassy carbon is often used in electrode and battery materials. Each of these forms of elemental carbon were tested with a dithionite compound and a base to test their activity for treatment of contaminants compared with activated carbon.

Two treatment test mixtures were prepared containing 1% w/w sodium dithionite, 500 mg/L of carbon, 0.2 M sodium hydroxide, and 5,000 μg/L TCE, The samples were each prepared by adding 0.200 g of sodium dithionite (Na₂S₂O₄) and 0.010 g of either graphite (Test 1), or amorphous, glassy carbon (Test 2) to a 20 mL glass vial, followed by 15.0 mL of water. Sodium hydroxide (4.0 mL, 1.0 M) was then added to the mixture and the vial was scaled and shaken briefly to dissolve the dithionite. The TCE stock solution (1.0 mL of 100 mg/L) was then added to the mixture by syringe. All vials in this study were sealed with leak-tight, PTFE, syringe-accessible caps. A TCE control sample was prepared by adding 1.0 ml, of a 100 mg/L TCE stock solution to 19.0 mL of water in a 20 mL sealed glass vial. The mixtures were shaken briefly and then stored at room temperature. After seven days, the TCE concentration in each water phase was measured by gas chromatography-mass spectrometry (GC-NIS). Samples were diluted by a factor of 20 in water for analysis. The sample names, compositions, and TCE concentrations in the reaction and control samples are shown in Table 7

TABLE 7

| | | [TCE] | Change vs. TCE |
|---|---|---|---|
| Sample | Composition | (μg/L) | control |
| Control | TCE | 3802 | — |
| Test 1 | Na₂S₂O₄/Graphite/NaOH/TCE | 3,468 | −9% |
| Test 2 | Na₂S₂O₄/amorphous carbon/ | 3,657 | −4% |
| | NaOH/TCE | | |

After 7 days, neither test condition showed a significant difference in TCE concentration when compared with the control (<10% change). This demonstrates that other allotropes of carbon, and other non-activated forms of amorphous elemental carbon are not as effective for destruction of contaminants when combined with a dithionite compound and a base, but could, in some situations, prove effective.

### Example 8

### Treatment of 1,1,1-TCA-Contaminated Water

This example demonstrates the destruction of 1,1,1-trichloroethane (TCA), a chlorinated ethane contaminant previously used as a solvent in multiple industries. The treatment is compared to two controls that distinguish TCA destruction from simple adsorption or volatilization processes.

A treatment mixture was tested containing 1% w/w sodium dithionite, 500 mg/i, colloidal activated carbon, 0.1 M sodium hydroxide, and 5,000 μg/L 1,1,1-trichloroethane (TCA). The sample was prepared by adding 0.200 g of sodium dithionite (Na₂S₂O₄) to a 20 mL glass vial, followed by 12.0 mL of water and 5.00 mL of 2,000 mg/L colloidal activated carbon (AC). Sodium hydroxide (2.0 mL, 1.0 M) was then added to the mixture and the vial was sealed and shaken briefly to dissolve the dithionite. The TCA stock solution (1.00 mL of 100 mg/mL TCA) was then added to the mixture by syringe. All vials in this study were sealed with leak-tight, PTFE, syringe-accessible caps. A TCA control sample (Control 1) was prepared by adding 1.00 mL of a 100 mg/L TCA stock solution to 19.0 mL of water in a 20 mL sealed glass vial. Control 2, an activated carbon/TCA control sample, was prepared by adding 5.00 mL of 2,000 mg/L colloidal activated carbon dispersion and 1.00 mL of a 100 mg/L TCA stock solution to 14.0 mL of water in a scaled vial. The mixtures were shaken briefly and placed on the laboratory bench at room temperature. After seven days, the TCA concentration in each sample was measured by gas chromatography-mass spectrometry (GC-NS). Samples were diluted by a factor of 20 in water for analysis. The sample names, compositions, and TCA concentrations in the reaction and control samples are shown in Table 8 below.

TABLE 8

| | | [TCA] | Change vs. TCA |
|---|---|---|---|
| Sample | Composition | (μg/L) | control |
| Treatment | Na₂S₂O₄/AC/NaOH/TCA | <100 | −98% |
| Control 1 | TCA | 4132 | — |
| Control 2 | AC/TCA | 3638 | −12% |

The treatment resulted in a 98% decrease in TCA concentration compared to a control with only TCA (Control 1). To account for any concentration decreases due only to adsorption, Control 2 was prepared with only activated carbon and TCA. Control 2 exhibited only a 12% decrease in contaminant concentration, demonstrating the efficacy of the present invention for destruction of TCA and treatment of TCA-contaminated groundwater and soil.

The foregoing, examples should be viewed as demonstrations of potential embodiments and are not exhaustive or necessarily conclusive as to the effectiveness of the present invention. In many situations, it may be preferable to utilize mixtures and conditions different from the above or use an embodiment of the invention which an example may have indicated was less effective but may be more optimal in such situation.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

It should be understood that while certain preferred forms, embodiments, and examples of this invention have been illustrated and described, the present invention is not to be limited to the specific forms or arrangement of parts described and shown, and that the various features described may be combined in other ways than those specifically described without departing from the scope of the present invention.

What is claimed is:

1. A method of treating or remediating contaminated groundwater or soil comprising the steps: adding to the groundwater or soil:
dithionite;
a sorbent material;
an alkaline pH controlling agent with a pH greater than 7.

2. The method of claim 1, wherein the sorbent material is activated carbon.

3. The method of claim 2, further comprising an initial step of mixing the dithionite, the activated carbon, and the pH controlling agent into a slurry.

4. The method of claim 3, wherein the dithionite: activated carbon is present in amounts relative one another by weight in a range of 1:0.001 to 1:100 and the pH controlling agent is present in sufficient amounts to raise the pH of the combination to greater than 9.

5. The method of claim 4, wherein the step of adding to the groundwater or soil is performed by injection.

6. The method of claim 5, wherein the injection comprises high pressure injection or fracturing.

7. The method of claim 5, wherein the injection comprises low pressure injection.

8. The method of claim 3, wherein the groundwater or soil is contaminated with at least one of the set comprising halogenated organic compounds, including but not limited to chlorinated ethenes, chlorinated ethanes, chlorinated methanes, chlorofhuorocarbons, polyfluorinated alkyl substances, and organochilorine pesticides.

9. The method of claim 3, wherein the groundwater or soil is contaminated with at least one chlorinated ethene from the set comprising perchloroethene, trichloroethene, dichloroethane isomers, and vinyl chloride.

10. The method of claim 3, wherein the groundwater or soil is contaminated with at least one organic nitro compound from the set comprising trinitrotoluene, hexogen, and octogen.

11. The method of claim 3, wherein the groundwater or soil is contaminated with at least one chemically reducible chemical from the set comprising chromium (VI) and perchlorate.

12. The method of claim 4, wherein the method comprises the additional step of: adjusting the ratio of dithionite and activated carbon in the slurry.

13. The method of claim 4, wherein the pH controlling agent is increased in ratio such that the pH is between 10 and 13.

14. The method of claim 13, wherein the method comprises the additional step of monitoring the pH level of the groundwater or soil and adding additional pH controlling agent if the pH falls out of the range of 10 to 13.

15. The method of claim 2, wherein the pH controlling agent is acidic with a pH less than 7.

16. A composition for use in groundwater remediation, the composition comprised of:
a sorbent material;
an alkaline pH controlling agent with a pH greater than 7;
dithionite; and
wherein the ratio of dithionite:sorbent material present in amounts relative one another by weight in a range of 1:0.001 to 1:100 and pH controlling agent is present in sufficient quantities to raise the pH of the composition to greater than 7.

17. The composition of claim 16, wherein the sorbent material comprises activated carbon.

18. The composition of claim 17, wherein activated carbon is selected from the group of granular activated carbon with an average particle diameter of greater than 1 mm, powdered activated carbon with an average particle diameter of between 5-50 μm, and colloidal activated carbon with an average particle diameter of 0.5-5 μm.

19. The composition of claim 16, wherein the pH controlling agent is selected from the group consisting of sodium hydroxide, potassium hydroxide, magnesium hydroxide, calcium hydroxide, sodium carbonate, potassium carbonate, sodium phosphate, and potassium phosphate.

20. A method of treating or remediating contaminated groundwater or soil comprising the steps:
creating a slurry comprised of dithionite and activated carbon wherein the ratio of dithionite:activated carbon are present in amounts relative one another by weight in a range of 1:0.001 to 1:100;
adding a substantially alkaline pH controlling agent to the slurry until the pH of the slurry is greater than 7;
adding the slurry to the groundwater or soil.
